(19) United States
(12) Patent Application Publication
(10) Pub. No.: US 2017/0178140 A1
(43) Pub. Date: Jun. 22, 2017

(54) SALES DATA PROCESSING APPARATUS

(71) Applicant: TOSHIBA TEC KABUSHIKI KAISHA, Tokyo (JP)

(72) Inventor: Tsutomu Kawamoto, Sunto Shizuoka (JP)

(21) Appl. No.: 15/345,680

(22) Filed: Nov. 8, 2016

(30) Foreign Application Priority Data
Dec. 17, 2015 (JP) 2015-246658

(51) Int. Cl. G06Q 20/40; G06Q 20/10

(52) U.S. Cl. CPC G06Q 20/4016; G06Q 20/102

(57) ABSTRACT

A sales data processing apparatus of the embodiment includes a sales registration unit configured to register sales of a commodity on which a sales registering operation is performed; an input unit configured to input customer specific information for specifying a customer; a security level setting unit configured to set a security level based on the customer specific information which is input by the input unit; and a fraud checking unit configured to check for fraud in the sales registering operation of the commodity based on the security level which is set by the security level setting unit.

### CROSS-REFERENCE TO RELATED APPLICATION

This application is based upon and claims the benefit of priority from Japanese Patent Application No. 2015-246658, filed Dec. 17, 2015, the entire contents of which are incorporated herein by reference.

### FIELD

Embodiments described herein relate generally to a sales data processing apparatus.

### BACKGROUND

In the related art, a self-sales data processing apparatus in which customers perform a sales registering operation relating to sales of sales items such as commodities in person has been proposed. In addition, the sales data processing apparatus has a fraud check function of checking for fraudulent sales registering operation performed by customers.

However, the sales data processing apparatus in the related art checks frauds with respect to all customers at a certain security level. Since it takes time to check for the fraud, it is inconvenient for many customers to use the self-sales data processing apparatus, and thereby the self-sales data processing apparatuses have not been widely used by customers.

JP-A-2015-141586 is an example of the related art.

### DESCRIPTION OF THE DRAWINGS

FIG. 1 is a diagram schematically illustrating a system including a self-POS terminal according to a first embodiment.

FIG. 2 is a perspective view illustrating an appearance of a self-POS terminal.

FIG. 3A to FIG. 3C are diagrams illustrating light-emitting states of a light-emitting device.

FIG. 4 is a block diagram illustrating a hardware configuration of the self-POS terminal.

FIG. 5 is a block diagram illustrating a hardware configuration of an attendant PC.

FIG. 6 is a functional block diagram illustrating a functional configuration of the self-POS terminal.

FIG. 7 is a flowchart illustrating a flow of control of the self-POS terminal.

FIG. 8 is a flowchart illustrating a flow of control of sales registration in the self-POS terminal.

FIG. 9 is a flowchart illustrating a flow of control in the attendant PC.

FIG. 10 is a diagram illustrating an example of a monitoring screen of the attendant PC.

FIG. 11 is a flowchart illustrating a flow of control of sales registration in a self-POS terminal according to a second embodiment.

FIG. 12 is a flowchart illustrating a flow of control of sales registration in a self-POS terminal according to a third embodiment.

FIG. 13 is a flowchart illustrating a flow of control of sales registration in a self-POS terminal according to a fourth embodiment.

### DETAILED DESCRIPTION

In general, according to one embodiment, there is provided a sales data processing apparatus which is capable of checking for fraud at a security level determined in accordance with a customer level.

The sales data processing apparatus of the embodiment is provided with a sales registration unit configured to register sales of a commodity on which a sales registering operation is performed; an input unit configured to input customer specific information for specifying a customer; a security level setting unit configured to set a security level based on the customer specific information which is input by the input unit; and fraud checking unit configured to check for fraud in the sales registering operation of the commodity based on the security level which is set by the security level setting unit.

### First Embodiment

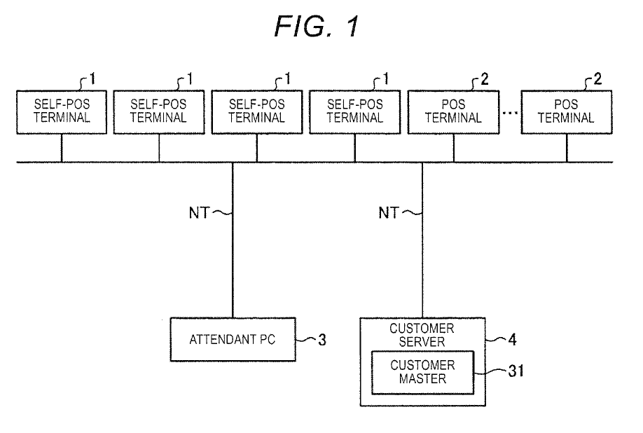

Hereinafter, a sales data processing apparatus according to the first embodiment will be specifically described with reference to the drawings of FIG. 1 to FIG. 10. In the first embodiment, a self-point of sales (POS) terminal will be described as an example of the sales data processing apparatus. Note that, the exemplary embodiments are not limited to the embodiments described below.

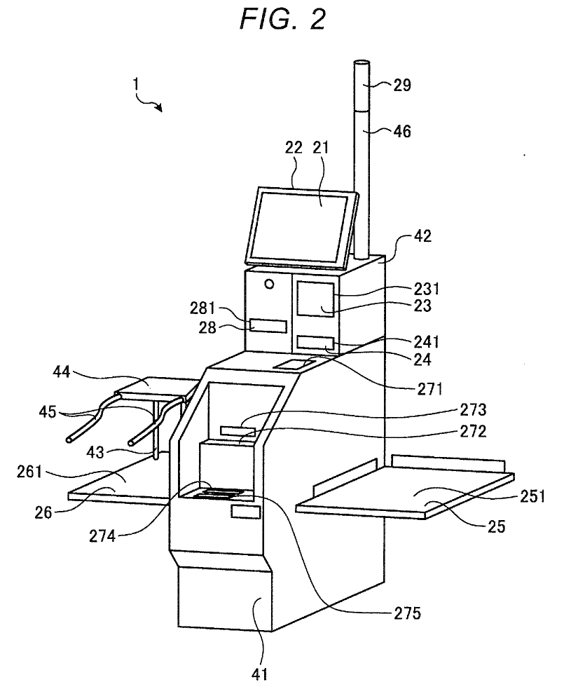

FIG. 1 is a diagram schematically illustrating a system including a self-POS terminal according to the first embodiment. As illustrated in FIG. 1, the system is configured to include a plurality of self-POS terminals 1 in which a customer performs a sales registering operation in person, a plurality of POS terminals 2 in which an operator performs the sales registering operation, an attendant personal computer (PC) 3, and a customer server 4. The self-POS terminal 1, the POS terminal 2, the attendant PC 3, and the customer server 4 are electrically connected to each other via a communication line NT such as local area network (LAN) line. Here, the sales registering operation means an operation of causing a reading unit 23 (refer to FIG. 2) to read a symbol attached on a commodity to be purchased.

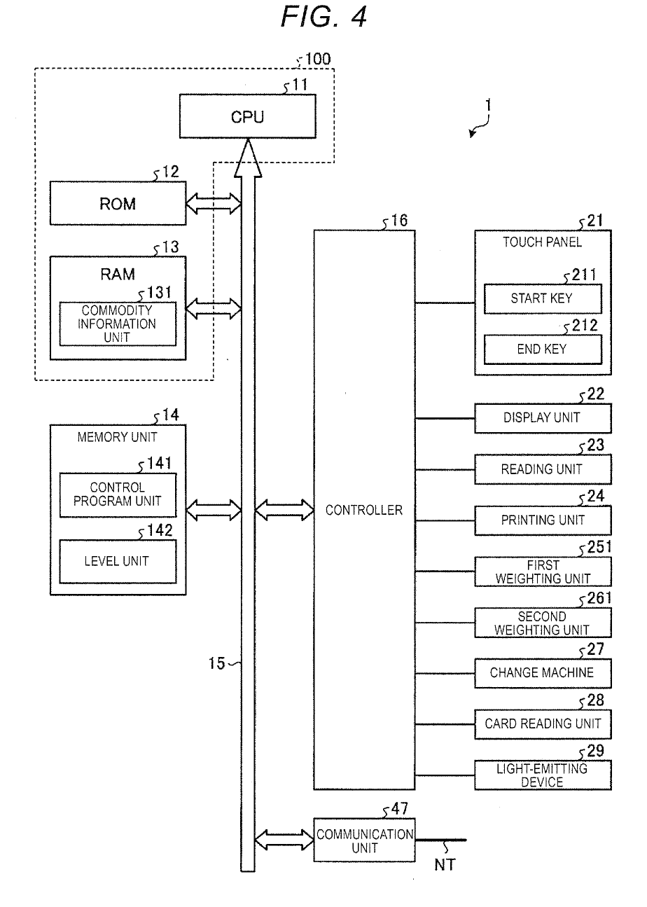

The self-POS terminal 1 according to the first embodiment specifies a customer by magnetically and electrically reading a customer code which is stored in a customer card inserted in a card reading unit 28. In addition, in response to the sales registering operation performed by the customer, the self-POS terminal 1 inputs the commodity code indicated by the symbol which is read by the customer. Then, the self-POS terminal 1 reads commodity information corresponding to the commodity code so as to register sales. In addition, when the customer operates an end key 212 (refer to FIG. 4) at the time of finishing the sales registering operation, and then inputs cash (referred to as a “payment operation”), the self-POS terminal 1 performs payment based on the information of the commodity which is sales-registered.

Here, the sales registration means a process of displaying commodity information on name and price of a commodity based on the input commodity code, and storing the commodity information in a commodity information unit 131 (refer to FIG. 4). In addition, the payment means a process of displaying payment information on the total amount relating to transaction, deposits deposited from the customers, and change or the like based on the information of the commodity which is sales-registered, and issuing a receipt on which the commodity information and the payment information are printed. Meanwhile, the transaction includes the sales registration and the payment. In addition, transaction information includes the commodity information and the payment information.

The self-POS terminal 1 receives level information of the customer which corresponds to a security level from the customer server 4 based on the input customer code. The level information of the customer is, for example, a level indicating the value of a customer, and in the embodiment, the aforementioned level includes a VIP customer level (Level 1 (a second security level)) and a standard customer level (Level 2 (a first security level)), for a store. The conditions for determining the level of the customer will be exemplified as described below. In the embodiment, the description will be made with reference to an example of (1). The security level at Level 1 is lower than the security level at Level 2.

In another embodiment, self-POS terminal 1 can have three security levels (where security level at Level 1 is lower than the security level at Level 2, which is lower than the security level at Level 3), four security levels (where security level at Level 1 is lower than the security level at Level 2, which is lower than the security level at Level 3, which is lower than the security level at Level 4), and so on.

(1) Use frequency of the self-POS terminal 1 by the customer within a predetermined period of time (for example, one month, but any time period can be employed). If the frequency of use is high, the level of the customer becomes the VIP customer level (Level 1). For example, the customer who uses the self-POS terminal 1 ten times or more per month qualifies for Level 1, and the customer who uses the self-POS terminal 1 less than nine times per month qualifies for Level 2 for the standard customer, which is lower than Level 1. For example, the level is determined for every month based on the frequency of use of the previous month.

(2) Total frequency of use of the self-POS terminal 1 and the POS terminal 2 by the customer within a predetermined period of time (for example, one month). If the total frequency of use is high, the level of the customer becomes Level 1. For example, the customer who uses the self-POS terminal 1 or the self-POS terminal 2 ten times or more per month qualifies for Level 1, and the customer who uses the self-POS terminal 1 or the self-POS terminal 2 less than nine times per month qualifies for Level 2. For example, the level is determined for every month based on the frequency of use of the previous month.

(3) Price of the commodity which is purchased by the customer within a predetermined period of time (for example, one month). For example, the customer who spends 100,000 yen or more for purchasing commodities during one month qualifies for Level 1, and the customer who spends less than 100,000 yen qualifies for Level 2. For example, the level is determined for every month based on the purchase price of the previous month.

Note that, the conditions for determining the level are not limited to those described above. For example, the level may be determined based on the frequency of visiting the store. In addition, the level may be determined based on contribution to the store. Further, the level may be determined based on whether or not many particular commodities are purchased. The level may be not only determined based on the frequency of use or the total amount within a predetermined period of time, but also determined based on a cumulative value of the frequency of use or the purchase amount until now.

The self-POS terminal 1 transmits various types of information to the attendant PC 3. Examples of the aforementioned various types of information include commodity information on the commodities which are sales-registered, payment information, and information indicating the amount and the number of currencies of variuos denominations which are stored in a change machine 27 (refer to FIG. 4), and an operating state of the self-POS terminal 1 (if the self-POS terminal 1 is being operated or is on standby). Further, examples of the aforementioned various types of information include error information (weighting error information, printer error information, card error information, and the like), and level information indicating the level of the customer who performs the operation, in the self-POS terminal 1.

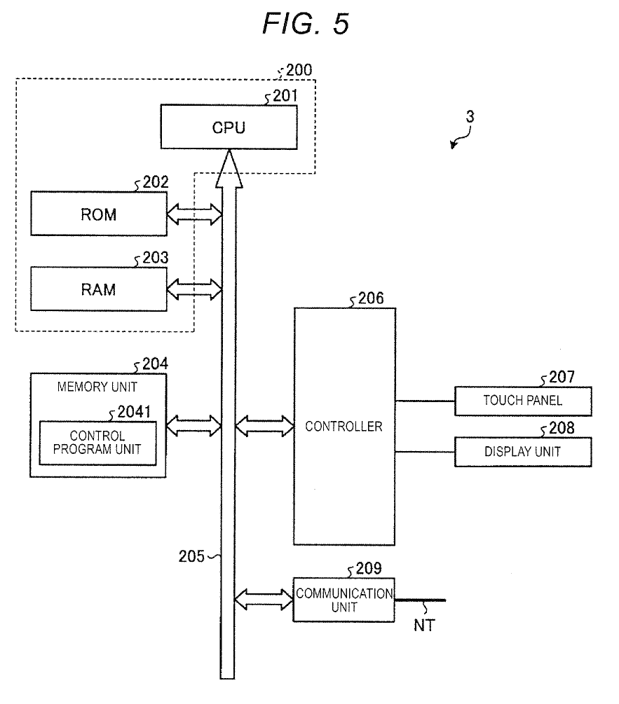

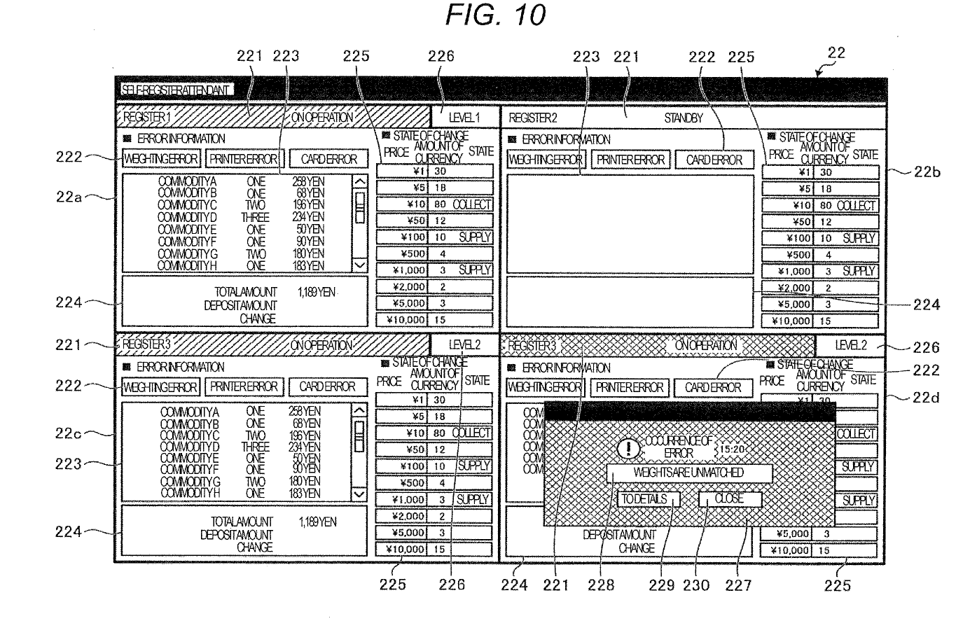

The attendant PC 3 is configured to include a PC or a mobile PC. The attendant PC 3 receives various types of information from the self-POS terminal 1 via a communication line NT. The attendant PC 3 displays the received various types of information on a display unit 208 (refer to FIG. 5 and FIG. 10). The attendant monitors use status or the occurrence of errors of the self-POS terminal 1, and the existence of fraud by the customer based on various types of information displayed on the attendant PC 3.

FIG. 2 is a perspective view illustrating an appearance of the self-POS terminal 1. As illustrated in FIG. 2, the self-POS terminal 1 is provided with a first housing 41 and a second housing 42. The first housing 41 accommodates the change machine 27 (refer to FIG. 4) and the like therein. The change machine 27 accommodates the currency deposited from the customer by the denominations, and gives the customer change.

In addition, the first housing 41 is provided with a deposit port 271 for depositing coins in the change machine 27, a discharging port 273 for discharging the coins from the change machine 27, and a receiving tray 272. Further, the first housing 41 is provided with a deposit port 274 for depositing bills in the change machine 27, and a discharging port 275 for discharging the bills from the change machine 27.

The first housing 41 is provided with a placing table 25 on which the basket including commodities to be purchased is placed, on the right side surface. The placing table 25 includes a first weighting unit 251. Further, the first housing 41 is provided with a placing table 26 to which a plastic shopping bag (not shown) into which the commodities are put is set, on the left side surface. The placing table 26 includes a second weighting unit 261. The first weighting unit 251 weighs the total weight of the basket displaced on the placing table 25 and commodities in the basket. The second weighting unit 261 weighs the total weight of the plastic shopping bag displaced on the placing table 26 and commodities in the plastic shopping bag.

In addition, the placing table 26 is provided with two main columns 43 extending upward from the upper surface of the placing table 26, a temporary placing table 44 which is formed on the upper portion of the main column 43, and two extension bars 45. The extension bar 45 is a bar for hooking the plastic shopping bag in which the commodities which are sales-registered are packed. The plastic shopping bag is opened in a state of being hooked by a handle of the extension bar 45 such that the commodities are easily put into the plastic shopping bag. Further, the temporary placing table 44 is a table on which a fragile commodity (tofu or eggs) among the commodities of which the commodity code is read by the reading unit 23 is temporarily displaced. The commodities displaced on the temporary placing table 44 are packed in to the bag last.

The second housing 42 is provided on the upper portion of the first housing 41. The second housing 42 accommodates the reading unit 23, a printing unit 24, and a card reading unit 28 therein. The reading unit 23 is, for example, a device for optically reading the commodity code included in the symbol attached on the commodity. The printing unit 24 issues a receipt from an issuing port 241 by printing the transaction information of the commodity purchased by the customer. The card reading unit 28 electrically reads the customer code from the customer card which is inserted from the inserting port 281. Note that, the customer code may be input by optically reading the symbol printed on the customer card by the reading unit 23.

In addition, the second housing 42 is provided with a display unit 22 which displays the commodity information of the commodity which is registered by the customer and accounting information, on the upper portion thereof. The display unit 22 displays guidance for the customer so as to properly perform the registering operation or an accounting operation, with respect to the customer. In addition, the display unit 22 displays a method of disabling an erroneous operation performed by the customer or a method of calling the attendant.

The display unit 22 is provided with a touch panel 21 on the surface thereof. The touch panel 21 serves as a key. The touch panel 21 corresponding to various keys which are displayed on the display unit 22 is operated so as to operate the corresponding key.

In addition, a cylindrical pole 46 which extends to the upper portion is provided on the rear side of the second housing 42. A tip end portion on the upper side of the pole 46 is provided with a light-emitting device 29 (refer to FIG. 2) which emits the light when the customer operates to call the attendant

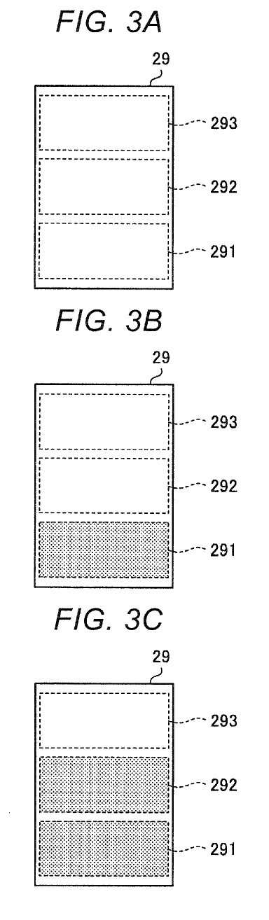

FIG. 3A to FIG. 3C are diagrams illustrating light-emitting states of the light-emitting device 29. The light-emitting device 29 is provided with a light-emitting unit 291, a light-emitting unit 292, and a light-emitting unit 293. When the customer is not operating the self-POS terminal 1, none of the light-emitting units emit the light (FIG. 3A). In addition, when the customer of Level 1 is operating the self-POS terminal 1, the light-emitting unit 291 emits the light (FIG. 3B). When the customer of Level 2 is operating the self-POS terminal 1, the light-emitting unit 291 and the light-emitting unit 292 concurrently emit the light (FIG. 3C). When an error has occurred in the self-POS terminal 1, the light-emitting unit 293 emits the light. Meanwhile, it is preferable that the light-emitting unit 291, the light-emitting unit 292, and the light-emitting unit 293 emit light having different colors from each other. For example, the light-emitting unit 291 emits blue light, the light-emitting unit 292 emits yellow light, and the light-emitting unit 293 emits red light. In addition, the light-emitting unit 291 and the light-emitting unit 292 may emit the same light (for example, the blue light), and the light-emitting unit 293 may emit the different color light (for example, the red light).

The customer puts out a commodity from a basket displaced on the placing table 25, and makes the commodities to pass through a front surface 231 of the reading unit 23 so as to read the symbol attached on the commodity by the reading unit 23. Then, the customer puts the commodity into a plastic shopping bag displaced on a placing table 26. When the first weighting unit 251 weighs the weight of the basket before and after the commodity is put out from the basket placed on the placing table 25, a control unit 100 (refer to FIG. 4) described below measures changed weight. When the second weighting unit 261 weighs the weight of the basket before and after the commodity is into the plastic shopping bag placed on the placing table 26, a control unit 100 described below measures changed weight. When the weight of the basket before the commodity is put out from the basket and the weight of the basket after the commodity is put out from the basket are the same as each other, the control unit 100 determines that the customer properly operates (that is, the customer does not perform a fraudulent operation). On the other hand, when the weight of the basket before the commodity is put out from the basket and the weight of the basket after the commodity is put out from the basket are different from each other, the control unit 100 determines that there is a possibility that the customer does not properly operate (that is, the customer performs a fraudulent operation).

Hereinafter, a hardware configuration of the self-POS terminal 1 and the attendant PC 3 will be described. FIG. 4 is a block diagram illustrating a hardware configuration of the self-POS terminal 1. As illustrated in FIG. 4, the self-POS terminal 1 is provided with a central processing unit (CPU) 11, a read only memory (ROM) 12, a random access memory (RAM) 13, a memory unit 14, and the like. The CPU 11 is a main controller. The ROM 12 stores various types of programs. The RAM 13 develops various items of data. The memory unit 14 stores the various types of programs. The CPU 11, the ROM 12, the RAM 13, and the memory unit 14 are connected to each other via a data bus 15. The CPU 11, the ROM 12, and the RAM 13 configure the control unit 100. That is, when the CPU 11 operates in accordance with the control program which is stored in the ROM 12 or the memory unit 14, and is developed in the RAM 13, the control unit 100 performs the following control process.

The RAM 13 includes a commodity information unit 131 which stores the commodity information. The memory unit 14 is configured to include a hard disc drive (HDD) which holds recording information even when the power is turned off, and a non-volatile memory such as a flash memory, and is provided with a control program unit 141 for storing control programs. In addition, the memory unit 14 includes a level unit 142. The level unit 142 stores the customer level received from the customer server 4 together with the customer code.

In addition, the control unit 100 is connected to the touch panel 21, the display unit 22, the reading unit 23, the printing unit 24, the first weighting unit 251, the second weighting unit 261, the change machine 27, the card reading unit 28, and the light-emitting device 29 via the data bus 15 and the controller 16.

The touch panel 21 is provided with a start key 211 corresponding to the display of the “start key” of the display unit 22, and an end key 212 corresponding to the display of the “end key” of the display unit 22. The start key 211 is operated by the customer who starts the operation of the self-POS terminal 1. The end key 212 is operated by the customer when the sales registering operation is finished with respect to the self-POS terminal 1. Note that, in the following description, “a key which is provided in the touch panel 21 corresponding to the display of the key of the display unit” is simplistically described such as “key displayed on the display unit”.

In addition, the control unit 100 is connected to the communication unit 47 via the data bus 15. The communication unit 47 performs transmission and reception of information between another self-POS terminal 1, the POS terminal 2, the attendant PC 3 via the communication line NT.

FIG. 5 is a block diagram illustrating a hardware configuration of the attendant PC 3. As illustrated in FIG. 5, the attendant PC 3 is provided with a CPU 201, a ROM 202, a RAM 203, and a memory unit 204. The CPU 201 is a main controller. ROM 202 stores various types of programs. RAM 203 develops various items of data. The memory unit 204 stores the various types of programs. The CPU 201, the ROM 202, the RAM 203, and the memory unit 204 are connected to each other via a data bus 205. The CPU 201, the ROM 202, and the RAM 203 configure the control unit 200. That is, when the CPU 201 operates in accordance with the control program which is stored in the ROM 202 or the memory unit 204, and is developed in the RAM 203, the control unit 200 performs the following control process.

The memory unit 204 is configured to include a hard disc drive (HDD) which holds recording information even when the power is turned off, and a non-volatile memory such as a flash memory, and is provided with a control program unit 2041 for storing control programs.

In addition, the control unit 200 is connected to the touch panel 207 and the display unit 208 via a data bus 205 and a controller 206. The display unit 208 displays various types of information received from the self-POS terminal 1.

In addition, the control unit 200 is connected to a communication unit 209 via the data bus 205. The control unit 200 performs transmission and reception of information between the self-POS terminal 1 and the POS terminal 2 via the communication unit 209 and the communication line NT.

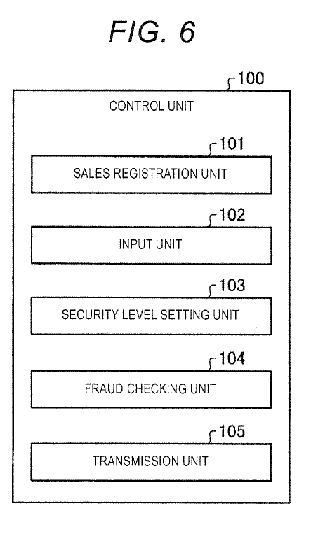

Hereinafter, the control of the self-POS terminal 1 and the attendant PC 3 will be described with reference to FIG. 6 to FIG. 10. FIG. 6 is a functional block diagram illustrating a functional configuration of the self-POS terminal 1. The control unit 100 serves as a sales registration unit 101, an input unit 102, a security level setting unit 103, a fraud checking unit 104, and a transmission unit 105, in accordance with the control program stored in the ROM 12 or the control program unit 141 of the memory unit 14.

The sales registration unit 101 has a function of registering sales of the commodity on which a sales registering operation is performed. The input unit 102 has a function of inputting the customer code for specifying the customer. The security level setting unit 103 has a function of setting the level of the customer based on the customer code which is input by the input unit 102. The fraud checking unit 104 checks the fraud of the sales registering operation of the commodity based on the customer level which is set by the security level setting unit 103. The transmission unit 105 has a function of transmitting the customer level to the external attendant PC 3 for monitoring the sales data processing apparatus.

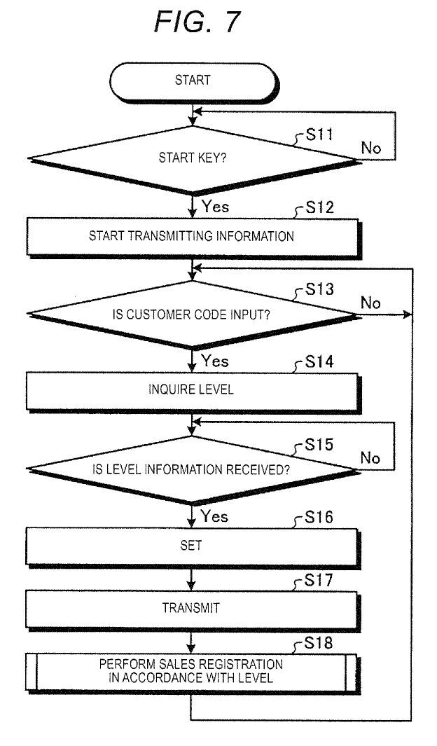

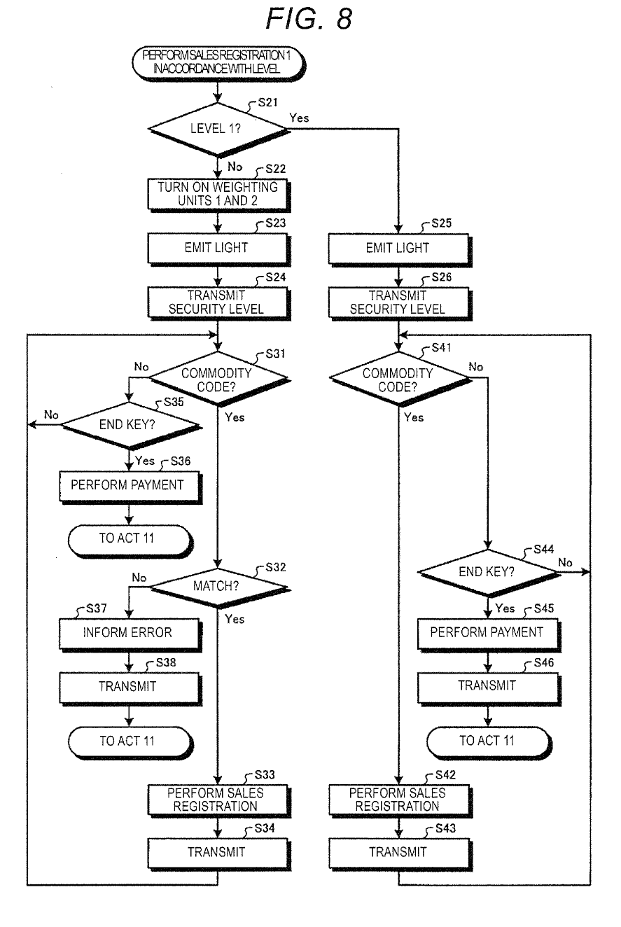

FIG. 7 and FIG. 8 are flowcharts illustrating a flow of control of the self-POS terminal 1. First, the control unit 100 determines whether or not the start key 211 is operated (Act 11). The start key 211 is operated by the customer when the operation of the self-POS terminal 1 is started. The control unit 100 waits until the self-POS terminal 1 is operated (No in Act 11). When it is determined that the self-POS terminal 1 is operated (Yes in Act 11), the control unit 100 starts to transmit various types of information to the attendant PC 3 (Act 12). At this point, the control unit 100 transmits the information indicating that the self-POS terminal 1 is in the operating state.

Next, the control unit 100 (input unit 102) determines whether or not the customer code is input (Act 13). The control unit 100 waits until the customer code is input (No in Act 13). When it is determined that the customer code is input (Yes in Act 13), the control unit 100 performs inquiry of the customer level with respect to the customer server 4 based on the input customer code (Act 14).

The customer server 4 which receives the inquiry information extracts the level information on the customer which is stored in a customer master 31 based on the received customer code. Then, the customer server 4 transmits the extracted level information of the customer to the self-POS terminal 1 in which the inquiry is performed.

The control unit 100 determines whether or not the level information on the inquiry of the customer level is received (Act 15). The control unit 100 waits until the level information is received (No in Act 15). When it is determined that the level information is received (Yes in Act 15), the control unit 100 (security level setting unit 103) sets the received customer level to the level unit 142 (Act 16). Then, the control unit 100 (transmission unit 105) transmits the received level information of the customer to the attendant PC 3 (Act 17). The attendant PC 3 displays level information 226 (refer to FIG. 10) of the customer in accordance with the received level information of the customer on the display unit 208. In addition, the control unit 100 performs sales registration in accordance with the customer level (Act 18).

FIG. 8 is a flowchart illustrating a flow of control of the sales registration in the self-POS terminal. In the first embodiment, a flow of the sales registration 1 which is performed in Act 18 by the control unit 100 in accordance with the customer level will be specifically described. In the sales registration 1 performed in accordance with the customer level, the control unit 100 performs the fraud checking of the predetermined security level with respect to the customer of Level 2 for all commodities to be purchased by the customer. However, the fraud checking is not performed with respect to customer of Level 1 (that is, the frequency of the fraud checking is decreased).

As illustrated in FIG. 8, the control unit 100 determines whether or not the customer level received in Act 15 is Level 1 (Act 21). When it is determined that the customer level is Level 2 (No in Act 21), the control unit 100 causes weighting functions of the first weighting unit 251 and the second weighting unit 261 to be turned on (Act 22). Then, the first weighting unit 251 and the second weighting unit 261 output signals in response to the weight of the commodity and the basket which are placed on the placing table. Based on the aforementioned signals, the control unit 100 weighs the changed weight when the commodity has been picked up from the placing table 25, and the changed weight when the commodity has been put into the plastic shopping bag placed on the placing table 26.

Next, the control unit 100 causes the light-emitting unit 291 and the light-emitting unit 292 of the light-emitting device 29 to emit the light (Act 23) so as to be in a state of FIG. 3C. In addition, the control unit 100 transmits the information on the customer of Level 2 and unique information (for example, a register number) for specifying the self-POS terminal 1 with respect to the attendant PC 3 (Act 24).

Next, the control unit 100 determines whether or not the commodity code is input from the reading unit 23 in accordance with the sales registering operation performed by the customer (Act 31). When it is determined that the commodity code is input (Yes in Act 31), the control unit 100 (fraud checking unit 104) determines whether or not the changed weight in the first weighting unit 251 and the changed weight in the second weighting unit 261 are matched with each other (Act 32). When the changed weights are matched with each other, the control unit 100 determines that there is no fraud in the sales registering operation performed by the customer. In contrast, when the changed weights are not matched with each other, the control unit 100 determines that there is possibility of a fraud in the sales registering operation performed by the customer. When it is determined that the changed weights are matched with each other (Yes in Act 32), the control unit 100 (sales registration unit 101) performs the sales registration based on the commodity code of the commodity which is input in Act 31 (Act 33). Then, the control unit 100 transmits the commodity information of the commodity which is sales-registered to the attendant PC 3 (Act 34). The control unit 100 returns to Act 31.

On the other hand, in Act 32, when it is determined that the changed weights are not matched with each other (No in Act 32), the control unit 100 causes the operation of the self-POS terminal 1 to stop, and informs the display unit 22 of the error information (Act 37). In addition, the control unit 100 causes the light-emitting unit 293 of the light-emitting device 29 to emit the light. Then, the control unit 100 transmits the aforementioned error information to the attendant PC 3 (Act 38). The control unit 100 returns to Act 11.

In addition, when it is determined that the commodity code is not input (No in Act 31) in Act 31, the control unit 100 determines whether or not the end key 212 is operated (Act 35). When it is determined that the end key 212 is operated (Yes in Act 35), the control unit 100 performs the payment based on the commodity information stored in the commodity information unit 131 (Act 36). Then, the control unit 100 returns to Act 11. Note that, when it is determined that the end key 212 is not operated (No in Act 35), the control unit 100 returns to Act 31.

On the other hand, it is determined that the customer level is Level 1 in Act 21 (Yes in Act 21), the control unit 100 causes the light-emitting unit 291 of the light-emitting device 29 to emit the light (Act 25) so as to be in a state of 3A. Then the control unit 100 transmits the information on the customer of Level 1 and the unique information (for example, the register number) of the self-POS terminal 1 with respect to the attendant PC 3 (Act 26).

Next, the control unit 100 determines whether or not the commodity code is input from the reading unit 23 in accordance with the sales registering operation performed by the customer (Act 41). When it is determined that the commodity code is input (Yes in Act 41), the control unit 100 performs the sales registration based on the commodity code of the commodity which is input in Act 31 (Act 42). Then, the control unit 100 transmits the commodity information of the commodity which is sales-registered to the attendant PC 3 (Act 43). The control unit 100 returns to Act 41.

In addition, when it is determined that the commodity code is not input (No in Act 41) in Act 41, the control unit 100 determines whether or not the end key 212 is operated (Act 44). In addition, when it is determined that the end key 212 is operated (Yes in Act 44), the control unit 100 performs the payment based on the commodity information stored in the commodity information unit 131 (Act 45). Then, the control unit 100 transmits the payment information on the finished payment to the attendant PC 3 (Act 46). The control unit 100 returns to Act 11. Note that, when it is determined that the end key 212 is not operated (No in Act 44), the control unit 100 returns to Act 41.

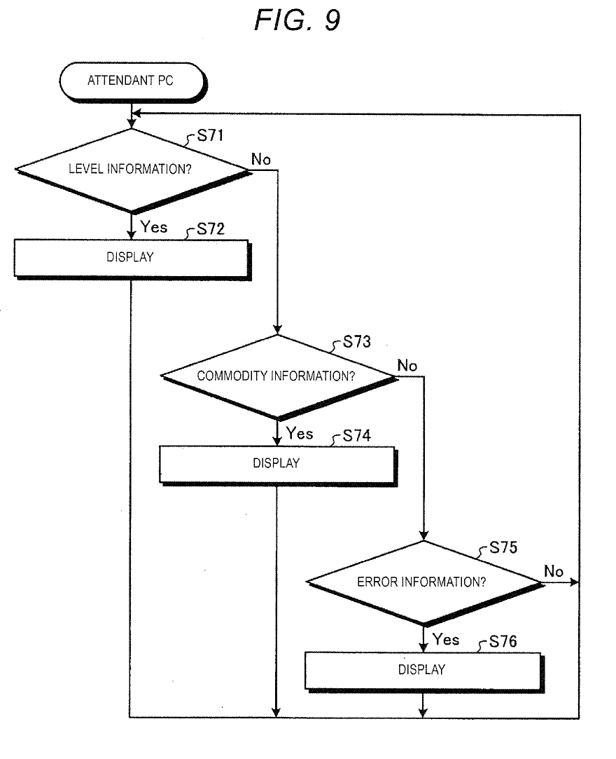

Hereinafter, the flow of controlling the attendant PC 3 will be described. As illustrated in FIG. 9, the control unit 200 determines whether or not the level information of the customer transmitted in Act 17 is received (Act 71). When it is determined that the level information of the customer is received (Yes in Act 71), the control unit 200 displays the aforementioned information on the corresponding monitoring screen based on the unique information which is concurrently received (Act 72). Then the control unit 200 returns to Act 71. Further, when it is determined that the level information of the customer is not received (No in Act 71), the control unit 200 determines whether or not the commodity information or the payment information which is transmitted from Act 34 or Act 46 is received (Act 73). When it is determined that the commodity information or the payment information is received (Yes in Act 73), the control unit 200 displays the aforementioned information on the corresponding monitoring screen (Act 74). Then, the control unit 200 returns to Act 71. In addition, when it is determined that the commodity information or the payment information is not received (No in Act 73), the control unit 200 determines whether or not the error information transmitted from Act 37 is received (Act 75). When it is determined that the error information is received (Yes in Act 75), the control unit 200 displays the aforementioned error information on the corresponding monitoring screen (Act 76). Then, the control unit 200 returns to Act 71. When it is determined that the error information is not received (No in Act 75), the control unit 200 returns to Act 71.

FIG. 10 is a diagram illustrating an example of the monitoring screen of the self-POS terminal 1 which is displayed on the attendant PC 3. In the example of FIG. 10, there are four self-POS terminals 1 to be monitored (registers 1 to 4). A monitoring screen 22a of the register 1 displays information 221 which indicates that the self-POS terminal 1 is being operated, error information 222 which indicates that the error has not occurred, commodity information 223 on the commodity which is sales-registered, payment information 224, amount information 225 on the amounts of the currencies stored in the change machine 27, and level information 226 which indicates the level of the customer who is operating the register 1. The level of the customer who is operating the register 1 is Level 1.

In addition, a monitoring screen 22b of the register 2 displays information 221 which indicates that the corresponding self-POS terminal 1 is on standby. Further, a monitoring screen 22c of the register 3 displays level information 226 which indicates the level of the customer which is operating the register 3. The level of the customer who is operating the register 3 is Level 2. Other pieces of information are the same as those in the register 1. In addition, a monitoring screen 22d of the register 4 displays error information 222 which indicates that an error relating to the weighing occurs during the operation, and pop-up information 227 which indicates the aforementioned error information in a large size. Error information 228 which indicates the aforementioned error information, a key 229 for specifically displaying the information of the aforementioned error, and a key 230 for closing the pop-up of the error information 228 are displayed on the pop-up information 227.

According to the first embodiment as described above, the sales registering operation of the customer of Level 2 is checked for the fraud. On the other hand, the sales registering operation of the customer of Level 1 is not checked for the fraud. In this way, in the first embodiment, the fraud checking is performed based on the security level in accordance with the customer level.

Hereinafter, a second embodiment to a fourth embodiment of the exemplary embodiment will be described. The second embodiment to the fourth embodiment are different from the first embodiment in that the fraud checking is performed even with respect to the customer of Level 1 in which the security level is low. Note that, the same portions as those in the first embodiment are denoted by the same reference numerals as those in the first embodiment, and the description thereof will not be repeated.

### Second Embodiment

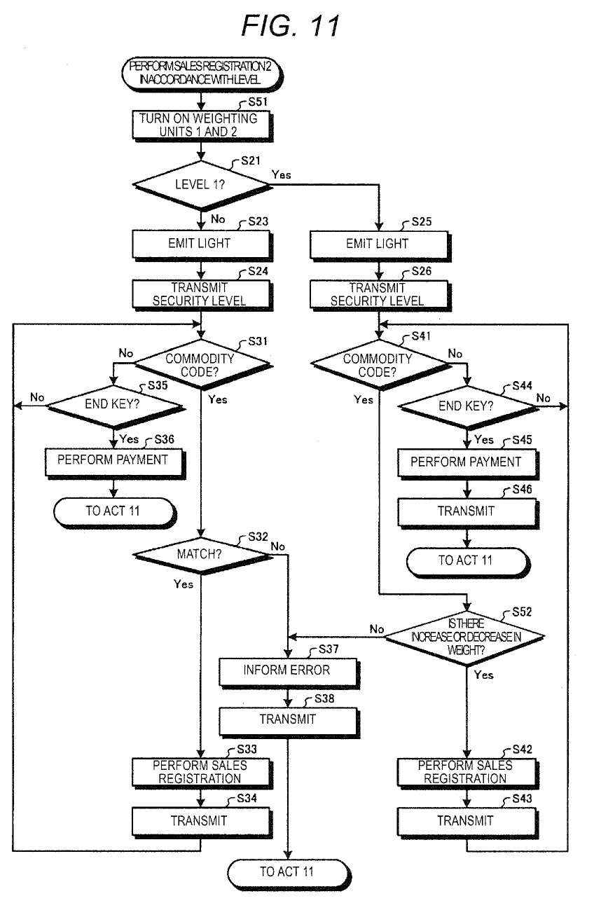

FIG. 11 is a flowchart illustrating a flow of control of sales registration in the self-POS terminal 1 according to the second embodiment. FIG. 11 specifically illustrates a flow of sales registration 2 which is performed in Act 18 by the control unit 100 in accordance with the customer level. In the second embodiment, before determining the level of the customer, weighting functions of the first weighting unit 251 and the second weighting unit 261 are set to be turned on (Act 51). Then, the control unit 100 determines whether or not the weight of the first weighting unit 251 is decreased, and the weight of the second weighting unit 261 is increased in the sales registering operation performed by the customer whose level is determined to be Level 1 (Act 52). In addition, if the weight of the first weighting unit 251 is decreased, and the weight of the second weighting unit 261 is increased, the control unit 100 determines that Act 52 is Yes (match of change weights is not determined). Then, when the control unit 100 determines the decrease and increase in the weight (Yes in Act 52), the control unit 100 performs the processes after Act 42. On the other hand, when the commodity code is input in Act 41, and it is determined that the weight of the first weighting unit 251 or the second weighting unit 261 is not changed (No in Act 52), the control unit 100 performs the processes after Act 37.

According to the second embodiment as described above, the fraud checking is performed with respect to the customer of Level 1 by lowering the security level as compared with the security level of the customer of Level 2. The aforementioned security level is determined based on whether or not the weight weighed by the first weighting unit 251 is decreased, and the weight weighed by the second weighting unit 261 is increased.

### Third Embodiment

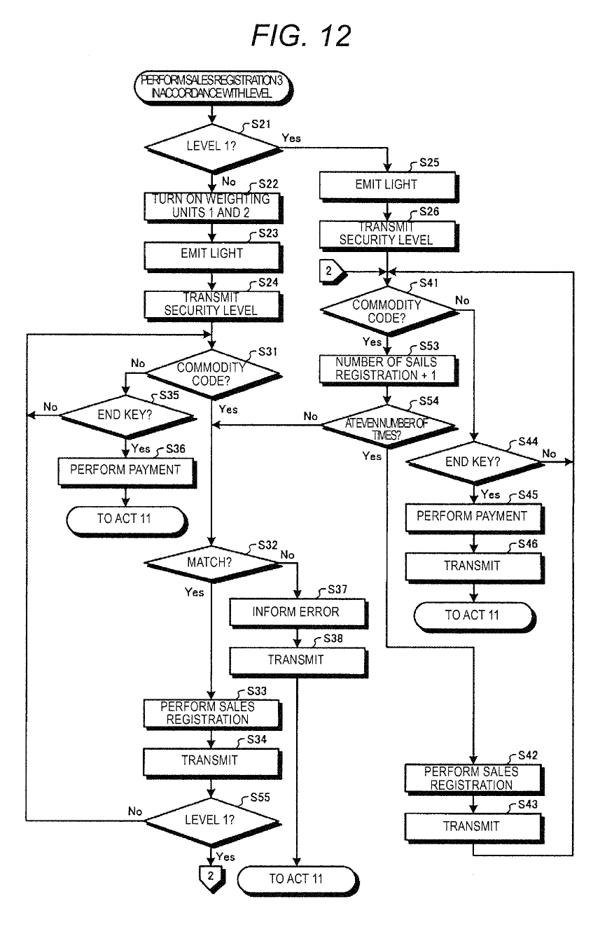

FIG. 12 is a flowchart illustrating a flow of control of sales registration in the self-POS terminal 1 according to a third embodiment. FIG. 12 specifically illustrates a flow of sales registration 3 which is performed in Act 18 by the control unit 100 in accordance with the customer level. In the third embodiment, regarding the customer of Level 1, the fraud checking is performed on a portion of the commodities on which a sales registering operation is performed during a single transaction. In the third embodiment, the fraud checking is not performed for the commodities which are sales-registered at even number of times, but is performed for the commodities which are sales-registered at odd number of times. For this reason, the control unit 100 counts the number of times of the sales registration (Act 53). Then, the control unit 100 determines whether or not the number of times of the sales registration which is counted immediately before is an even number (Act 54). When the number of times of the sales registration is the even number (Yes in Act 54), the control unit 100 performs processes after Act 42 without performing the fraud checking. On the other hand, when it is determined that the number of times of the sales registration is an odd number (No in Act 54), the control unit 100 performs the processes after Act 32. In addition, the control unit 100 determines again whether or not the level of the customer is Level 1 after performing the process of Act 34 (Act 55). If the level of the customer is Level 1 (Yes in Act 55), the control unit 100 returns to Act 41, and if the level of the customer is Level 2 (No in Act 55), the control unit 100 returns to Act 31.

According to the third embodiment as described above, when the number of times of the sales registration is the even number, the fraud checking is not performed (that is, the frequency of the fraud checking is lowered) with respect to the customer of Level 1. In this way, the fraud checking is performed with respect to the customer of Level 1 by lowering the security level as compared with the security level of the customer of Level 2.

### Fourth Embodiment

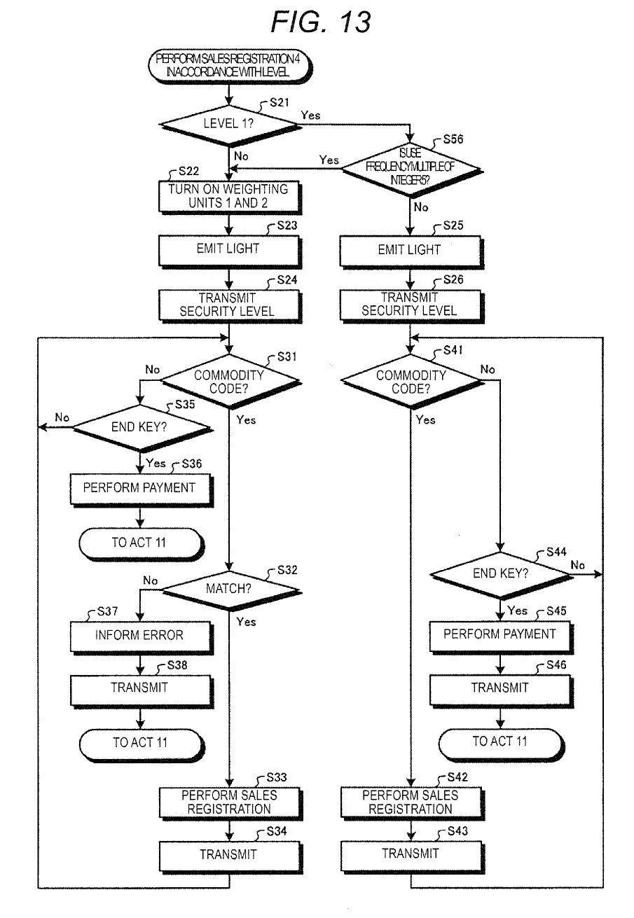

FIG. 13 is a flowchart illustrating a flow of control of sales registration in the self-POS terminal 1 according to a fourth embodiment. In FIG. 13, a flow of the sales registration 4 which is performed in Act 18 by the control unit 100 in accordance with the customer level will be specifically described. In the fourth embodiment, the fraud checking is performed with respect to the customer of Level 1 when the frequency of use of the self-POS terminal 1 is a predetermined number of times. For this reason, the control unit 100 determines the frequency of use of the self-POS terminal 1 by the customer of Level 1 (Act 56). In the embodiment, it is determined whether or not the frequency of use of the self-POS terminal 1 by the customer of Level 1 is a multiple of integer 5 (a predetermined value). The customer server 4 stores the frequency of use of the self-POS terminal 1 by the customer. For this reason, when the customer level is received in Act 21, the frequency of use of the self-POS terminal 1 by the customer is also received. The control unit 100 determines Act 56 based on the received frequency of use. When the frequency of use is not the multiple of 5 (No in Act 56), the control unit 100 performs the processes after Act 25 without performing the fraud checking. In addition, when the frequency of use is the multiple of 5 (Yes in Act 56), the control unit 100 performs the processes after Act 22. Note that, in the embodiment, Act 56 is determined based on the frequency of use of the self-POS terminal 1; however, Act 56 may be determined based on the total frequency of use of the self-POS terminal 1 and the POS terminal 2.

According to the fourth embodiment as described above, when the frequency of use of the self-POS terminal 1 is not a predetermined value, the fraud checking is not performed (that is, the frequency of the fraud checking is lowered) with respect to the customer of Level 1. In this way, the fraud checking is performed with respect to the customer of Level 1 by lowering the security level as compared with the security level of the customer of Level 2.

As described above, the exemplary embodiments are described; however, these embodiments are merely described as examples, and are not intended to limit the scope of the exemplary embodiment. These embodiments can be newly performed with other various configurations, and it is possible to make various omissions, substitutions, and changes without departing from the scope of the exemplary embodiment. These embodiments and their modifications are included within the scope and spirit of the exemplary embodiment and included within in the exemplary embodiment as described in the appended claims and the scope equivalents thereto.

For example, in the embodiments, the security level of the customer of Level 1 is set to be lowered as compared with the case of the customer of Level 2; however, the exemplary embodiment is not limited thereto. For example, the fraud checking may be performed with respect to the customer who has fraudulently performed the operation in the past based on the security level being set to be higher than Level 2.

Further, in the embodiment, the fraud checking is performed by using two weighting units of the first weighting unit 251 and the second weighting unit 261; however, the exemplary embodiment is not limited thereto. For example, the fraud checking may be performed based on the weight weighted by using the first weighting unit 251 or the second weighting unit 261, and the weighting information of the commodity which is stored in advance.

In addition, in the embodiment, the fraud checking is performed by weighing the commodity; however, the exemplary embodiment is not limited thereto. For example, the fraud checking may be performed by capturing an image of the commodity to be extracted from the placing table 25 and an image of the commodity to be put into the plastic shopping bag, and then determining the match of the commodities based on information on the captured images by using a general image recognition technology.

Further, in the embodiment, the basket including the commodity is placed on the placing table 25; however, the exemplary embodiment is not limited thereto. For example, the cart including the commodity may be transported to the position of the placing table 25 and the commodity may be directly extracted from the cart without being placed on the placing table 25. In this case, the first weighting unit 251 is not necessary, and the fraud checking is performed by using the second weighting unit 261.

Moreover, in the embodiment, the customer master 31 for storing the customer level is stored in the customer server 4; however, the exemplary embodiment is not limited thereto. For example, the self-POS terminal 1 itself may store a customer master corresponding to the customer master 31 from the beginning.

While the invention is explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

What is claimed is:

1. A sales data processing apparatus comprising:
a sales registration unit configured to register sales of a commodity on which a sales registering operation is performed;
an input unit configured to input customer specific information for specifying a customer;
a security level setting unit configured to set a security level based on the customer specific information which is input by the input unit; and
a fraud checking unit configured to check for fraud in the sales registering operation of the commodity based on the security level which is set by the security level setting unit.

2. The apparatus according to claim 1,
wherein the security level is determined in accordance with frequency of use of the sales data processing apparatus.

3. The apparatus according to claim 1, wherein
the security level comprises a first security level and a second security level which is lower than the first security level, and
the fraud checking unit makes a frequency of fraud checking which is performed with respect to the commodity when the security level is the second security level lower than a frequency of fraud checking when the security level is the first security level.

4. The apparatus according to claim 3,
wherein the fraud checking unit does not perform the fraud checking with respect to the commodity when the security level is the second security level.

5. The apparatus according to claim 1, further comprising:
a transmission unit configured to transmit the security level to an external device for monitoring the sales data processing apparatus.

6. The apparatus according to claim 1,
wherein the security level is determined in accordance with frequency of use of the sales data processing apparatus within a predetermined period of time.

7. The apparatus according to claim 1,
wherein the security level is determined in accordance with an amount of goods purchased.

8. The apparatus according to claim 1,
wherein the security level is determined in accordance with an amount of goods purchased within a predetermined period of time.

9. The apparatus according to claim 1, wherein
the security level comprises a first security level, a second security level, and a third security level, the second security level is lower than the first security level, and the third security level is lower than the second security level.

10. A sales data processing method for a sales data processing apparatus comprising:
registering sales of a commodity on which a sales registering operation is performed;
inputting customer specific information for specifying a customer;
setting a security level based on the input customer specific information; and
checking for fraud in the sales registering operation of the commodity based on the security level.

11. The method according to claim 10,
wherein setting the security level is determined in accordance with frequency of use of the sales data processing apparatus.

12. The method according to claim 10, wherein
the security level comprises a first security level and a second security level which is lower than the first security level, and
checking for fraud comprises making a frequency of fraud checking which is performed with respect to the commodity when the security level is the second security level lower than a frequency of checking for fraud when the security level is the first security level.

13. The method according to claim 12,
Wherein checking for fraud does not comprise checking for fraud with respect to the commodity when the security level is the second security level.

14. The method according to claim 10, further comprising:
a transmission unit configured to transmit the security level to an external device for monitoring the sales data processing apparatus.

15. The method according to claim 10,
wherein setting the security level is determined in accordance with frequency of use of the sales data processing apparatus within a predetermined period of time.

16. The method according to claim 10,
wherein setting the security level is determined in accordance with an amount of goods purchased.

17. The method according to claim 10,
wherein setting the security level is determined in accordance with an amount of goods purchased within a predetermined period of time.

18. The method according to claim 10, wherein
the security level comprises a first security level, a second security level, and a third security level, the second security level is lower than the first security level, and the third security level is lower than the second security level.
